(19) United States
(12) Patent Application Publication
(10) Pub. No.: US 2014/0281869 A1
(43) Pub. Date: Sep. 18, 2014

(54) VARIABLE SIZE TABLE TEMPLATES, INTERACTIVE SIZE TABLES, DISTRIBUTABLE SIZE TABLES, AND RELATED SYSTEMS AND METHODS

(71) Applicant: Susan Yob, San Jose, CA (US)

(72) Inventor: Susan Yob, San Jose, CA (US)

(21) Appl. No.: 14/212,507

(22) Filed: Mar. 14, 2014

Related U.S. Application Data
(60) Provisional application No. 61/794,224, filed on Mar. 15, 2013.

(51) Int. Cl. G06F 17/24

(52) U.S. Cl. CPC G06F 17/245; G06F 17/246; G06F 17/248
USPC 715/217

(57) ABSTRACT

Described herein are Interactive Size Tables, Variable Size Table Templates, Distributable Size Tables, and related systems and methods that execute and enable generating, publishing, distributing, displaying, modifying, viewing, and interacting with online Interactive Size Tables. Interactive Size Tables are client customizable size tables with interactive features, and, may be generated using Variable Size Table Templates. An example of an executable user interactive feature is size selection by tapping a size displayed on an Interactive Size Table. Another interactive feature is the multiple format feedback feature, which allows users to choose from several different feedback formats and to leave user feedback in sections proximate utilized Interactive Size Tables. User feedback is then made available online and reportable back to generating clients, along with other metrics and usage fees, through a client data purchase and billing interface. Interactive Size Tables are cloud storable and remotely accessible, modifiable, publishable, and efficiently distributable.

### CROSS-REFERENCE TO RELATED APPLICATIONS

This application claims priority from a U.S. provisional patent application No. 61794224, confirmation #2877, filed Mar. 15, 2013, and entitled “Variable Size Table Templates, Interactive Size Tables, Distributable Size Tables, and Related Systems and Methods” by the same applicant, which is hereby incorporated by reference.

### FEDERALLY SPONSORED RESEARCH

None

### SEQUENCE LISTING

None

### BACKGROUND

The following is a reference that appears relevant: U.S. Pat. No. 7,310,883, Kind Code B1, issue Date: Dec. 25, 2007, Patentee: Park.

This relates to systems and methods for generating, publishing, distributing, displaying, modifying, viewing, and interacting with size tables, and also rating and leaving feedback proximate size tables; specifically to Interactive Size Tables, Distributable Size Tables, and Variable Size Table Templates.

Currently when users lookup and attempt to find the needed size of an item, users view size information on state of the art fixed size tables, also known as size charts, which lack interactive capabilities. State of the art fixed size tables due to their static format may be inaccurate, imprecise, old, and inconsistent within and across brands and metrics, amongst markets, and between countries. Also, generators of current fixed size tables produce standard static state of the art fixed size tables which are merely viewable online because standard fixed size tables are often displayed to users in read only formats which lack technology based interactive capabilities. As such, for users, current fixed size tables do not allow systems based linked size selections and feedback communications, as claimed herein.

It is estimated that online returns can run as high as 35 to 40 percent of all online purchases and size issues are one of the top reasons remote shoppers report as the reason for returns. To get around the unreliability of state of the art fixed size tables, some users may order the same item in several sizes, try them all for size, and then return items that do not fit. In the event that items ordered do not fit due to size issues, some users leave poor ratings and less than positive review feedback right next to items for sale rather than proximate the size table, which also may have the effect of dissuading others from buying the item due to subjective size uncertainty. Thus, merchants who provide standard fixed size tables often have goods returned due to size issues and also have a lack of sales for items with poor size related reviews left in common review sections that mention all types of problems, including size problems. Today, state of the art fixed size tables lack the capacity to offer specific size table sections to leave size detailed feedback and other sections as described herein.

Currently, generators of online fixed size tables, for example product designers and manufacturers, are not generating, modifying, publishing, and globally distributing interactive size tables that allow the generator of the size table to later partially edit, modify, add to, update, upload, and redistribute to client merchants and users, interactive, revised, and up to date size tables. Additionally, generators of fixed size tables offer no direct size feedback sections on the display page of fixed size tables, and receive no feedback and metrics comprising how many people actually selected a size from any given fixed size table, which size was selected from any given fixed size table, and how the user rated and reviewed the size purchased based upon the accuracy of the referenced fixed size table.

In some cases, based upon fixed size table sizes provided by merchants, coupled with reviews added by previous buyers of an item, users may mentally recall a size they usually order, only to discover that the item was manufactured smaller or larger than before. Concurrently, those depending upon fixed size tables, for example manufacturers, distributors, online merchants of online items, buyers, and advertisers, due to lack of feedback may be unapprised of size table issues. Also currently, if one size is wrong on a given size table, originators of size tables must take down the entire size table because they lack a variable based, global, and systematic technology based way to update any given fixed size table to reflect to users actual sizes of items by replacing discrete size table data errors and reposting corrected versions. Also, currently available fixed size tables are not enabled to provide user and size feedback to those who generate fixed size tables. As such current fixed size tables do not have the capacity to provide systems based feedback loops.

From the perspective of users of fixed size tables, fixed size tables often present to users imprecise ranges and unpredictable sizing, leaving users guessing about the critical decision of size selection. Currently, online users are able only to view fixed sized tables and have to memorize their size from current fixed size tables and then make their actual size selection away from the fixed size table rather than upon the size table itself. Accordingly, current users of online fixed size tables cannot interactively select their size from fixed size tables, nor, after a purchase, provide feedback on the same page as the fixed size table.

In so far as I am aware, Interactive Size Tables; Distributable Size Tables; Variable Size Table Templates; and related systems and methods disclosed herein do not exist and as such are novel and useful. Interactive Size Tables; Distributable Size Tables; Variable Size Table Templates; and related systems and methods comprising technology based systems and methods as disclosed herein produce many novel and useful advantages comprising:

(a) beyond viewing a size table, allowing a user to interact with a size table, for example for one embodiment, tap select a size from an online Interactive Size Table and have selected size sent to and appear in an online shopping cart;

(b) allow a client user to generate, upload, store, edit, modify, download, publish, display, and distribute Interactive Size Tables;

(c) allow a client user to generate, upload, store, edit, modify, download, publish, display, and distribute an Interactive Size Table using Variable Size Table Templates and associated data, thereby allowing a user to interact online with up to date size tables;

(d) allow a client user to selectively modify, upload, store, edit, modify, download, publish, display, and redistribute an existing size table using online computing, and local and remote data storage and servers;

and (e) allow users of Interactive Size Tables to leave feedback in multiple formats on the same page as the Interactive Size Table and allow client users the option to have feedback data looped back to appropriate parties.

### SUMMARY

Interactive Size Tables may be generated, published, and distributed by clients comprising manufacturers, designers, pattern makers, vendors, merchants, retailers, etailers, online catalog creators, online table creators, scanners, virtual fitting rooms and any others interested in generating Interactive Size Tables; viewed online by users and generating clients; and interacted with by users for actions regarding an item of interest comprising viewing and sending input comprising selecting, relocating selection, sizing, quantifying, highlighting, entering notes, calculating, converting metrics and currency, rating, and leaving feedback in multiple formats. Interactive Size Tables which employ Variable Size Table Templates and related methods and systems are originated and updated by generating clients, viewable online, and interacted with by users. Interactive Size Tables provide interactive features comprising selectable hyperlinks, buttons, note pads, calculators, conversion calculators, zooming in and out, mouse over popup windows, written feedback systems, rating systems, audio feedback systems, video feedback systems, animations, virtual fitting rooms, customizable features, and combinations of these and other client customizable features. Users may also interact with other optional sections of Interactive Size Tables comprising how to size sections, fitting systems, user profile systems, how to use sections, how to wear sections, how to measure sections, and a printable measuring tape.

As such, one embodiment disclosed herein comprises variable derived Interactive Size Tables that may be electronically generated and viewed comprising interactively linked sizes that may be viewed and selected by users in order to select a size on said Interactive Size Table and to have said selected size electronically copied to memory and moved and displayed in another location, for example into an online shopping cart. Another embodiment incorporates widgets in the user interface of client generated Interactive Size Tables, allowing users to request and enable size suggestions based upon one or more correlations of user supplied measurement data and generating client supplied data. For one embodiment of said size suggestions, users interactively select, for example screen tap corresponding size to select, per required size variable, for instance a shoe size requires two variables, foot length and foot width. The length is interactively selected with one variable size table screen tap and width of the foot is selected with another variable size table click. User supplied size selections are then correlated with generating client data and size suggestions are estimated and are made known to users. Said size suggestions are indicated to users in ways comprising highlighting of the suggested size, opening a small window displaying the suggested size, and sending size suggestions to another location.

While shoes were herein used as one example, Interactive Size Tables may be used with anything that is quantifiable with a size table. Further examples are mentioned to exemplify the broad application and utility of Interactive Size Tables, but in no way to limit the applications and uses of Interactive Size Tables further comprising clothing, footwear, bedding, draperies, jewelry, accessories, eyewear, windows, doors, parts, building supplies, autos, boats, trucks, hardware, pictures, frames, furniture, household items, fabric, patterns, molds, notions, machines, components, computers, phones, packaging, and office supplies.

Another embodiment allows online users to enter and save one or more user profiles and have that saved information interpreted, stored, accessed, displayed, and correlated with size data provided by generating clients. Upon entering the Interactive Size Table graphic user interface, a widget window pops up asking users if they wish to input a profile and allows users to create and access stored user profiles. Users may refuse the profile input option and proceed directly to Interactive Size Tables or choose to sign in using a graphic user interface. Once signed in, verified, and logged in, users enter and may customize and save profile and data to a processing site database. User profiles comprising name, age, weight, items and associated weights and measurements, body measurements, preferences, past purchases, past feedbacks, wish lists, favorites, likes, dislikes, links, show size information, hide size information, and other user provided information, preferences, and data may be stored and processed. Users may log out and save profiles. Saved profiles may be edited by said users at a later time. Saved user profiles are accessible by authorized and verified users and usable at and by client websites and their affiliate websites, for example within the Interactive Size Table and by the size suggester.

Processing site data comprising user profile data, user feedback data, click item data, click size data, and size suggest data may be collected and reported to clients; used by and with fitting systems; and further analyzed by the processing site. Use metrics are accounted for and billed to clients through a billing interface.

After users experience Interactive Size Tables and then buy, receive, and try items, experienced users may be granted permission and may choose to leave feedback in feedback sections of the Interactive Size Table in several different formats comprising: as input into overall size feedback ratings and scores; as written feedback; picture format; in audio feedback format, in video feedback format, and in any combination of said feedback formats.

### Advantages

Accordingly advantages are provided to both generating clients and users by Interactive Size Tables which employ Variable Size Table Templates, Interactive Size Tables, Distributed Size Tables, and related methods and systems. Advantages are provided to generating clients comprising: providing a means for generators of size tables to generate, publish, distribute, add to, update, and modify individual variables of size tables based upon actual size of items; receiving Interactive Size Table generated feedback via written, audio, fax, and email advisories and warnings; enabling generating clients to define where users leave size feedback so that if there is a size issue and once said size tables are corrected, user overall reviews, ratings, scores, and feedback are less prone to be negatively based upon size and therefore less likely to damage future item sales and brand image due to sizing issues disclosed in reviews on item main pages and in search engines which may be detrimental for years; providing same screen size table and size selections that allow user size selections to be placed into a shopping cart from Interactive Size Tables, thus increasing the probability of a sale by not disrupting the sale and checkout by opening other windows to view fixed size tables and perform mental calculations; providing generating client the option to add how to size, use, and wear items and associated fit information, with formats comprising pictures, graphics, writings, videos, and audio; and reducing item returns and saving money, time, and brand images by having the real time ability to generate, correct, and modify said size tables, thus more accurately informing online users so they may be less likely to return items based upon wrong size selections due to outdated fixed size tables or inconsistencies of sizing schemes used by different countries, manufacturers, and brands.

As importantly, advantages are provided to users of Interactive Size Tables comprising: providing users more accurate and current size information so that users are satisfied with the size of the item when it arrives and do not return item due to size issues; providing users an option to interactively input required and actual variables, for example measurements, for items; request suggested sizes; and highlight suggested size in the Interactive Size Table; providing users note pads and calculators to assist in size calculations and size conversions from one metric to another; providing linked size selection from the Interactive Size Table in order to place user selected size into shopping cart from an Interactive Size Table; providing online purchasers of items interactive feedback systems and methods comprising scoring systems, rating systems, and picture, audio, and video feedback formats, that may be monitored by generating clients who are then able to use the systems disclosed herein to investigate and if necessary correct any size issues directly on said variable template associated with corresponding Interactive Size Table using related methods and systems disclosed herein; saving users the hassle, time, money, and costs associated with return items; and saving users time they will have to spend finding another item of the correct size.

Those skilled in the art will appreciate that many different combinations of hardware, software, and firmware will be suitable for practicing Variable Size Table Templates; Interactive Size Tables; Distributable Size Tables; and related systems and methods. It should be understood that processes and techniques described herein are not inherently related to any particular apparatus and may be implemented by any suitable combination of components. Further, various types of general purpose devices may be used in accordance with the teachings described herein. Also it may be advantageous to construct specialized apparatus to perform the method steps described herein. All examples used to describe and use Variable Size Table Templates, Interactive Size Tables, Distributable Size Tables, and related systems and methods are intended to be illustrative rather than restrictive.

Variable Size Table Templates, Interactive Size Tables, Distributable Size Tables, and related systems and methods, have been described herein, in relation to particular embodiments, which are intended in all respects to be illustrative rather than restrictive. Many different combinations of hardware, software, and firmware will be suitable for practicing Variable Size Table Templates, Interactive Size Tables, and Distributable Size Tables, related systems and methods. Additionally, other implementations of Variable Size Table Templates, Interactive Size Tables, Distributable Size Tables, and related systems and methods are apparent from this disclosure. Various aspects and components of the described embodiments may be used singly or in any combination. It is intended that the specification and embodiments be considered exemplary only, with the scope and the spirit of Variable Size Table Templates, Interactive Size Tables, Distributable Size Tables, and related systems and methods with which said size tables interact as described in further detail herein.

A computer-generated Variable Size Table Template comprises: one or more rows, each row defined by a row variable; one or more columns, each column defined by a column variable; one or more intersecting locations, located where a row variable intersects a column variable, each said intersecting location defined by an intersecting location variable; at least one interactive feature variable; and a computing system.

Variable Size Table Templates contain at least one definable variable and also may be composed of combinations of variables. The variables are definition assignable and modifiable, may be enabled with interactive features, and may be enabled with customizable interactive features. The variables may be user defined from input comprising text, numbers, data, pictures, audio, video, graphics, scans, fax, voice, and animations.

Interactive features for Interactive Size Tables, Variable Size Table Templates, and Distributable Size Tables comprise select by clicking; select by tapping; sliding; highlighting; hyperlinks; linking; buttons; widget activated features; one or more popup windows; a secure login feature; create and save an account feature; measuring feature; one or more data mouse over popup windows; one or more audio features; one or more video features; how to use, wear, and measure features; an item ratings input feature; an item review input feature; a calculator; a conversion calculator; a notepad; a size suggest; a fitting system; a place item into shopping cart feature; and a printable measuring tape feature.

Variable Size Table Templates may include one or more sections beyond the size table wherein: said sections comprise size suggests; feedback and rating systems; information; multiple table layer tabs; combinations of more than one said section; and customizable sections. Also, sections are variable, input accepting, modifiable, selectable, movable, zoomable in and out, placeable, stackable, interactive, and publishable. Additionally, sections accept input comprising text, numbers, data, pictures, audio, video, graphics, scans, fax, voice, and animations.

Also, Variable Size Table Templates may have one or more layers. For example, one or more additional size table templates may be stacked, selected, brought forward, and pushed back. A variable definition key may be included on a Variable Size Table Template, where client generating users may define variables near the size table on a Variable Size Table Template.

The Variable Size Table Template has a computing system which generates an Interactive Size Table from a Variable Size Table Template and also from customizable client generated table formats.

A client may publish, modify, display, and republish an Interactive Size Table generated from a variable size template, to files, in databases, on flash and disc drives, to another computing software, to another computing system, and also on one or more remote servers. Users of the Interactive Size Table may use the published Interactive Size Tables to look up and determine the accurate size they need and to interact with the Interactive Size Table, including sections. For example, users may access the Interactive Size Table next to a desired online item, select a size, click on the selected size located on the Interactive Size Table, and have the size selected on the Interactive Size Table also entered at another location.

An Interactive Size Table is comprised of one or more rows with one or more row descriptors; one or more columns with one or more column descriptors; one or more reference descriptors located where row descriptors intersect column descriptors; at least one interactive feature; and a computing system. Row descriptors, column descriptors, and reference descriptors may have customizable labels. For example, the row and column labels may comprise sizes and size ranges, dimensions, measurements and measurement ranges, weights and weight ranges, quantifications, titles, letters, numbers, letter and number combinations, country name, combinations and customizations of all of the above labels, and generating user defined labels.

The computing system of an Interactive Size Table generates and publishes an Interactive Size Table, which originates from sources comprising a client developed size table; table making and development software; from a Variable Size Table Template; and from combinations and customizations based on incorporating the client developed size table, and Variable Size Table Templates. Publishing also comprises any display of the Interactive Size Table.

Once generated and published, users access, view, and interact with Interactive Size Tables and may interact online with Interactive Size Tables. Users of Interactive Size Tables have interaction options comprising choosing to open an Interactive Size Table; selecting a size; selecting to have a size suggested; placing a selected size in another location; switching from one Interactive Size Table to another; choosing to open a fitting system; making calculations; printing a measuring tape; watching and listening to instructional audio and video; using a notepad; inputting reviews, ratings, and feedback by choosing from multiple formats; placing item in shopping cart; and exiting session.

The Interactive Size Table also may include sections in addition to the size table area of the table. Additional sections may be enabled to be selectable and interactive. Interactive features are selected from a group comprising select by clicking; select by tapping; highlighting; hyperlinks; buttons; one or more popup windows; a secure login feature; create and save a user profile; measurements; items viewed; purchased to my account feature; one or more data mouse over popup windows; one or more audio features; one or more video features; how to use, wear, and measure features; an item ratings input feature; an item review input feature; a calculator; a conversion calculator; a notepad; a size indicator; a size suggester; a fitting system; a place item into shopping cart feature; and a printable measuring tape feature.

Interactive Size Tables may also have one or more layers. For one embodiment, a three layer Interactive Size Table may include tabbed tables, one tabbed table for women's clothing, one tabbed table for men's clothing, and one tabbed table for children's clothing. Additional Interactive Size Tables may be tabbed, interactively stacked, selected, brought forward, and pushed back.

One embodiment of the computer system comprises: a processing site with at least one database configured to store data; a Variable Size Table Template Module configured to store Variable Size Table Templates; a client variable size table generator module configured to generate an Interactive Size Table on a generation interface, wherein the generation interface is configured to enable a client user to generate an Interactive Size Table from data stored in said database and from a completed template from the Variable Size Table Template module; and a publishing module configured to enable a client user to publish a generated Interactive Size Table.

Additional embodiments of the computer system include one or more user interfaces. Examples of interfaces are graphic user interfaces comprising a client graphic user interface; a client data purchase and billing graphic user interface; and a graphic user interface. Interfaces are configured to securely receive data from a user and a client user, and transmit the data to one or more databases and other locations.

The computer system also has a publishing module that is configured to publish the Interactive Size Table with interactive features. One embodiment has an interactive size selection feature that facilitates selection of a size from the Interactive Size Table, whereby a size selected by a user may be transferred to other locations. Another embodiment has an interactive size suggester feature, whereby when a user selects to have at least one size suggested, the user enters the measurements they are seeking and then correlations between user measurements and sizing data are computed, the suggested size, and in some cases, sizes are highlighted in the Interactive Size Table.

For one embodiment, the computer system generating interface comprises size table variable defining and assigning variable values, and is configured to receive and save client user data and client selected Variable Size Table Template. The client selected variable size template is then populated with client data, wherein the generating module automatically generates the Interactive Size Table from data stored in the data module.

The Interactive Size Table has interactive features that are selected from a group comprising: a select by clicking feature; a select by tapping feature; highlighting; hyperlinks; buttons; one or more popup windows; a secure login feature; create and save a user profile; measurements; items viewed; purchased to my account feature; one or more data mouse over popup windows; one or more audio features; one or more video features; how to use, wear, and measure features; an item ratings input feature; an item review input feature; a calculator; a conversion calculator; a notepad; a size suggest; a fitting system; a place item into shopping cart feature; and a printable measuring tape feature.

The engine of the processing site embeds interactive features into the Interactive Size Table. For one embodiment, the programmed interactive features are selected from a group of application programming interfaced widgets, enabling interactions comprising selecting, displaying, linking, tabbing, scrolling, text and value inputting, outputting, and windowing.

A novel feature of distributed size tables, Interactive Size Tables, Variable Size Table Templates, and supporting computer systems is the computer-implemented method of centralized distribution and editing of size tables. The distributed size table is stored at a processing site location and is accessed, edited, generated, published, and distributed by permitted users. For one embodiment, generating users of a size table after initial posting of the size table, are allowed to log into their account again, view the existing size table, and edit as much and as little of the size table, from the entire table to only one element, and then from a centralized location, republish and redistribute the modified size table immediately to all websites that call upon the size table assigned address.

In the case of a published fixed size table that is inaccurate and requires editing, the fixed size table generator must track down, if possible, all released and posted versions of a fixed size table that need to be changed; separately take posted files with the inaccurate size tables down off the web, locate the master fixed size table file that originated the fixed size table, edit the master fixed size table file offline, distribute the edited fixed size table to those needing the corrected fixed size table, who then upload the modified fixed size table to their own sites. With one embodiment of distributed size tables described herein, a size table is stored at a centralized location, for example a cloud server, and distributed upon publication to all client permitted vendors, merchants, manufacturers, and designers, at a common access address.

One embodiment of the computer-implemented method of modifying a distributed size table comprises: opening a client user account on a user interface; selecting published size table to be edited; modifying at least one existing element of said size table; saving modified size table to database; and publishing and distributing online, a modified size table.

One embodiment of computer-implemented method for a client to generate, publish, and distribute an Interactive Size Table from a Variable Size Table Template comprises: provide a variable size table generating interface; allow the client user to view and select a Variable Size Table Template, wherein a Variable Size Table Template is stored in a Variable Size Table Template Module located on a remote server; receive a client selection of a Variable Size Table Template; allow a client user to open and customize a variable size table; receive the client user input and the template data, storing said client user input and said template data in database; generate automatically an Interactive Size Table with at least one interactive feature, using said stored client user data and client user customizations; save a copy of the customized Variable Size Table Template and generated Interactive Size Table to the client user account; and publish and distribute an Interactive Size Table.

One embodiment of computer-implemented method for a client to generate, publish, and distribute an Interactive Size Table from a client customized size table comprises: allow client to securely log into an account; import client size table; interpret and format client size table data; generate an Interactive Size Table; publish said Interactive Size Table; distribute said Interactive Size Table online.

One embodiment of a computer-implemented method for using the interactive size selection feature of an Interactive Size Table comprises: allow a user to enable an Interactive Size Table; open a client generated Interactive Size Table; allow a user to select an interactive size from the Interactive Size Table; allow a user to verify size selection; count an Interactive Size Table interaction; add said counting to a client user account metrics and billing record; place a user selected size in same location as the corresponding item; get permission from a user to add the selected item with selected size in the online shopping cart; place a selected item into the online shopping cart; count an Interactive Size Table interaction with shopping cart placement; add said count to said client user account metrics and billing record; allow a user to continue shopping; allow a user to end session; and allow a user permission to later leave feedback.

One embodiment of a computer-implemented method for a user to leave feedback on an Interactive Size Table and email and charge a client using the client data purchase billing interface comprises: open the Interactive Size Table; receive a user request to access a feedback section; verify that a user purchased an item using the corresponding Interactive Size Table; grant a user permission to interact with requested feedback section; allow a user to leave feedback input on the item corresponding Interactive Size Table; store the user feedback input in the database; publish the user feedback on the feedback section of the Interactive Size Table; send a copy of the user feedback to the client user account; and charge the client user account using the client data purchase billing interface.

### DRAWINGS

FIG. 1 is one embodiment of a Variable Size Table Template for United States women clothing sizes.

FIG. 2 is a client template for one embodiment of an all client defined Variable Size Table Template.

FIG. 3 is one embodiment of an international Variable Size Table Template.

FIG. 4 is one embodiment of a Variable Size Table Template for shoes for men, with how to measure foot diagram and section.

FIG. 5 is one embodiment of a Variable Size Table Template with layer tabs and sections.

FIG. 6 is a block diagram of one embodiment of a computing system.

FIG. 7 is a flowchart diagramming one embodiment of an online user experience.

FIG. 8 is a block diagram for generating and publishing an Interactive Size Table from a Variable Size Table Template.

FIG. 9 is a flowchart of a client user interaction with a Variable Size Table Template.

### DETAILED DESCRIPTION

FIG. 1 is a series of four tables: one embodiment of a Variable Size Table Template for United States women clothing sizes 110 with 72 definable size variables within the variable size table, 150; one typical fixed United States generic size 120; one variable key table with dimension variables defined 130; and one variable key table with client defined table heading variables defined 140. FIG. 1 also shows, along the left side of the Variable Size Table Template 110, defined descriptor variables. The second to the top row of the Variable Size Table Template 110 is a row of heading size letter and number defined descriptor variables, for example a manufacturer may wish to use fixed descriptors such as XS, S, M, L, 1×, 2×, 3×. Also, the Variable Size Table Template includes, at the cross-section of descriptor variable of the left side and descriptor variable at the second row, resides a corresponding measurement variable 150, which contains a corresponding measurement. Additional top lines and tabs may be added to further categorize sizing, for example above XS, S, M, L; Regular Sizes may be indicated, and above XL, XXL, XXXL; Plus Sizes may be indicated. All variables have the potential to be made into links and which variables are linked is an option provided to the generator of the table.

Other embodiments of Variable Size Table Templates may use the standard US Size Chart variables as shown in FIG. 1, the standard International Size Chart variables as illustrated in FIG. 3, and combinations of variables and variations based upon these two standard fixed tables. Still other embodiments may use measurements taken from the actual manufactured item, once made, so that the actual measurements are available. FIG. 5 shows an embodiment with multiple tables overlapping with menu tabs 514 at the upper edge of the Variable Size Table Template. An exemplary multiple, overlapping size table would have mens, womens, children size table menu tabs, that when clicked upon would bring to view the respective variable and Interactive Size Table.

FIG. 2 is a Variable Size Table Template for one embodiment of an all client defined Variable Size Table Template 230 with a definable variable key 240; a detail specification variable 220; a title variable allowing a client to name the size table on the size table template 210; and an infinite possibility of table measurement variables 250, allowing for a customizable size table size.

FIG. 3 is a Variable Size Table Template for an international size table template for four countries; USA 310, UK 320, GERMANY 330, and AUTRALIA 340. Also, FIG. 3 has a variable key 350 that defines V the defined specification variable 360 and the N, the variable title 370 of the international size table. The international size table template is customizable, easily expanded to add more countries, and easily reduced in size by including fewer countries.

FIG. 4 is one embodiment of a Variable Size Table Template for shoes for men comprising a title N 412; a shoe size listing column 410 with generic shoe sizes 6 through 18 plus infinity 424 if more variables need to be added; a heel toe length in inches column 414 with client defined variables A through Z 418 plus infinity 424, if more heel toe length variables in inches need to be added; a heel toe length in centimeters column 416 with client defined variables a through z 418 plus infinity 424, if more heel toe length variables in centimeters need to be added; a shoe width row 426 with shoe width headings for both inches and centimeters 428; and a how to measure foot for shoes diagram section, with instructions 430 explaining how to take length 420 and width 422 foot measurements on a drawing of a foot 432. This embodiment could also have added sections comprising calculators and a note pad to take down measurements.

FIG. 5 is one embodiment of a multiple layer, Variable Size Table Template comprising definable tabbed layers 514; a title variable 510, allowing a client user to name the Interactive Size Table using a size table template; a variable size template of layer one 520; a reviews and ratings section of a Variable Size Table Template 530; an audio and video feedback section 540; a size suggester and fitting room systems section of a Variable Size Table Template 550; a how to use an item section of a Variable Size Table Template 560; a how to wear section of a Variable Size Table Template 570; a how to measure section of a Variable Size Table Template 580; a printable measure tape section of a Variable Size Table Template 584; an input receiving note pad section of a Variable Size Table Template 590; a calculator section of a Variable Size Table Template 595; and a conversion calculator section of a Variable Size Table Template 598.

### REFERENCE NUMERALS

110 is one embodiment of a Variable Size Table Template for United States women clothing sizes.
120 is a generic United States clothing size table for women with size ranges
130 is a key for dimension variable size table for the Variable Size Table Template above the key.
140 is a key for client defined table heading variables.
150 is one of the 72 definable size variables found within the table.
210 is a title variable allowing a client to name the size table on the size table template.
220 is a detail specification variable key.
230 is a client defined Variable Size Table Template with customizable size.
240 is a key for variable definitions corresponding to Variable Size Table Template variables.
250 is one of many measurement variables that make up the Variable Size Table Template.
310 is a Variable Size Table Template for the USA.
320 is a Variable Size Table Template for the UK.
330 is a Variable Size Table Template for the GERMANY.
340 is a Variable Size Table Template for the AUSTRALIA.
350 is a variable definitions key.
360 is the variable V that defines a detailed specification.
370 is a title variable allowing a client to name the international size table on the size table template.
410 is the shoe size column entitled Shoe Size
412 is a variable size template title variable N.
414 is a client defined variable for heel to toe length in inches.
416 is a client defined variable for heel to toe length in centimeters.
418 is a client defined variable for length A to Z measurements in inches and length a to z measurements in centimeters.
420 is where to measure the length of a foot.
422 is where to measure the width of a foot.
424 is a row marked with the infinity symbol for each length and width variable column.
428 is a row of shoe width variables N and n.
430 is a section explaining how to measure a foot for sizing the length and width of a shoe.
432 is a drawing of foot marked with a length of foot line and a width of foot line.
510 is a title variable allowing a client user to name the Interactive Size Table using a size table template.
514 are definable tab table variables for tabs 1 through 6 layers.
520 is a Variable Size Table Template table.
530 is reviews and ratings section of a Variable Size Table Template.
540 is an audio and video feedback section of a Variable Size Table Template.
560 is a size suggester and fitting room systems section of a Variable Size Table Template.
560 is a how to use an item section of a Variable Size Table Template.
570 is a how to wear section of a Variable Size Table Template.
580 is a how to measure section of a Variable Size Table Template.
584 is a printable measure tape section of a Variable Size Table Template.
590 is an input receiving note pad section of a Variable Size Table Template.
595 is a calculator section of a Variable Size Table Template.
598 is a conversion calculator section of a Variable Size Table Template.
610 is one embodiment of a processing site.
611 is a site of a client user interface.
612 is the client site where users access the Interactive Size Tables.
613 is a site of a user interface for direct logging into use account and creating profiles.
614 is a user interface.
615 allows for scan and fax input.
616 is a client user interface.
618 is client agent data.
619 is an agent that tracks user data while at the client site.
620 is a login and verifier for secure login to the computing system.
622 are Interactive Size Tables.
624 are size suggesters.
625 is checkout.
626 are users feedback.
628 is an engine.
629 is a shopping cart.
630 is an interpreter.
632 is cloud computing over the internet.
640 is a data module 1.
650 is a client variable size table generation module.
660 is a converter.
670 is a director.
680 is data module 2.
692 is an accounting module.
694 is a client data purchase, billing interface.
710 is user input to enable sizing information.
720 is a question to user.
722 is a question to a user.
724 is where user inputs login.
725 is where user inputs and saves information.
726 is where user opens size suggester.
728 is where size correlations are computed.
730 is where user selects and verifies size.
732 is size is selected.
734 is where users select size and size automatically is moved to item location.
736 is a question to users to asking to put item with selected size into shopping cart.
740 gives user the option to continue the current session.
746 gives user the option to end the session.
802 is the online client user web portal.
804 is the client user interface.
806 is where the Variable Size Table Templates are stored.
808 is where the data is stored.
810 is the Interactive Size Table generator.
812 is the Interactive Size Table publisher.
814 is the cloud computing site.
816 is the online client specified website.
910 is a client a graphic user interface having access to variable size templates.
920 is where a client selects and opens a variable size template.
940 is where a client user saves the variable size template.

### Operation

FIG. 6 illustrates one embodiment of a computing system with a processing site 610 comprising: login and verifiers 620 for secure logins; a converter 660; an interpreter 630; a data module 1, 640; a client variable size table generation module 650; an engine 670; a data module 2, 680; and an accounting 692 module. Online clients access and communicate with the processing site, and, input data to the processing site via the internet 632 using the client user interface 616. The computer system accepts client input as text, voice, audio, video using the client user interface. Also, the computer system accepts fax and scan input 615. Clients may also use a data purchase and billing interface 694.

FIG. 6 also illustrates a site 613, where a user interface 614 allows users to securely 620 log into a user account, set up a user account, and create a user profile that comprises sizing measurements, fitting sessions, items purchased, and saved items. Users may interface with the computing system from a client website and at any client authorized site that display at least one of the following: an Interactive Size Tables 622, size suggesters 624 and online fitting systems, shopping cart 629, checkout 625, and user feedback 626. Engine 628 drives the process from site 612 to processing site 610.

Size suggesters correlate sizes provided by a user utilizing the processing site engine that compares user measurements with client data stored in data module 1. An agent 619 collects and transfers agent data 618 via the internet to the processing site, and records and stores tracking data in data module 2, 680. User feedback also may be stored in data module 2. Clients may view and purchase user data through the data purchase and billing interface 694 where metrics comprising user hits, Interactive Size Table usage, and ratings may be accounted for by accounting 692.

The client variable size table generation module 650 is configured to generate variable size tables comprising text, numbers, letters, symbols, data, graphics, animations, pictures, audio, and video features; and memory coupled to the processor to store generated variable size tables and features disclosed herein. FIG. 6 shows within the processing site, the client Variable Size Table Template generation module 650, for client generated functions comprising generating, updating, adding to and modifying said variable size table with said features and client defined sections, variables, and data.

According to another aspect of Variable Size Table Templates, a computer-implemented method is provided that includes clients information input via GUI, text, voice, audio, and video input, and scan/fax uploading variable size tables from a computer over the internet, using cloud computing, and transmitting and storing in databases variable size tables on one or more servers, said servers awaiting and fulfilling requests to download Variable Size Table Templates at said server to a computing device and transmitting an object that includes said variable size table to the computer in response to the request to download said variable size tables with said features.

FIG. 7 shows a flowchart of one embodiment of a computer-implemented method for using the interactive size suggester feature of an Interactive Size Table comprises: allow a user to enable Interactive Size Tables for an item 710; give a user the option to use an interactive size suggester 722; ask a user if they wish to save a size; whereby if a user wishes to save a size, said user securely logs into a user account 724 and creates a user profile with measurements 725; open a user selected size suggester 726; receive a user supplied set of measurements; compute automatically a size analyzing correlations between user input and client generated data 728; select a corresponding size on an Interactive Size Table 730; open an Interactive Size Table with size selected 732, whereby size stands out from other sizes on the Interactive Size Table; allow a user to select the suggested size 734; allow a user to verify selection; count and track an Interactive Size Table interaction; place a user selected size in same location as item; ask a user if said user wishes the selected item with selected size to be placed in a shopping cart 736; place selected item in a shopping cart 738; count and track an Interactive Size Table interaction with shopping cart; allow a user to continue shopping 740; allow a user to end session 746; and allow a user to return at a later time and leave feedback.

FIG. 8 shows one embodiment of the generating process for generating and publishing an Interactive Size Table, from a Variable Size Table Template, using a client user interface 804 from an online client user web portal 802. Variable Size Table Templates are stored 806. Variable Size Table Templates are composed of customizable sections comprising rows, columns, intersections of rows and columns, titles, text, graphics, logos, menus, pictures, picture feedback, audio feedback, video feedback, written feedback, ratings, note pad, calculators, conversion calculators, ads, scores, pictures, videos, and graphics illustrating and explaining features about how to size, measure for, wear, and use items. Also, said sections of variable size tables are composed of variables comprising item identifiers, sizes, measurements, weights, quantifications, titles, descriptions, mnemonics, codes, letters, words, numbers, letter and number combinations, blank areas, pictures and picture configurations, note pad configuration, calculator and calculator conversion configurations, video definitions and configurations, graphics definitions and configurations, ratings and customizable client generated variables. Once an Interactive Size Table has been generated 810 using data 808 and templates 806, the Interactive Size Table is published using a publisher 812 and stored on cloud servers 814. Server uploaded Interactive Size Tables may be downloaded to online client specified websites 816 via user computing devices comprising computers, laptops, notebooks, smart phones, tablets, and mobile devices, and interactively and graphically viewed, with sections and defined variables selectable, enabled, and usable.

FIG. 9 show a flowchart of one embodiment of a computer-implemented method for transforming a variable size template into an Interactive Size Table comprises: provide a client a graphic user interface 910 having access to variable size templates; receive a client user selection 920 of a variable size template, wherein the variable size table is stored in a Variable Size Table Template module; receive a client user input 930; complete the variable size template; save the variable size template to a database 940; generate automatically the Interactive Size Table using stored client user data; and publish and distribute the Interactive Size Table.

Interactive Size Tables are then accessed by users interested in sizing and quantifying items. Interactive Size Tables have interactive quantitative and qualitative generating client variables comprising sizes, measurements, weights, titles, descriptions, mnemonics, codes, letters, words, numbers, letter and number combinations, pictures, videos, graphics, ratings and others that may be selected by users in order to choose a size on the size table and have said selected size copied to another location, for example into online shopping carts, near the item, and, to enable size suggestions based upon measurements, one click per required size variable. For example for a shoe, the length requires one input click and width of the foot requires another input click; and to access feedback ratings, written feedback, picture feedback, audio feedback, and video feedback. After all said required defined variables are clicked, the system generates a correlated size and highlights linked size within said size table, enabling users to select the suggested linked table size. After users use said systems and methods, users who purchased an item are granted permission and may choose to leave feedback in feedback sections of the Interactive Size Table in several different formats comprising: as input into overall size feedback ratings and scores; in written feedback format; in picture feedback format; in audio feedback format; in video feedback format; and in a selected combination of said feedback formats.

I claim:

1. A size table template comprising:
one or more rows, each row defined by a row variable;
one or more columns, each column defined by a column variable;
one or more intersecting locations, located where at least one row variable intersects at least one column variable, each said intersecting location defined by an intersecting location variable;
at least one interactive feature variable;
and a computing system.

2. The size table template of claim 1, wherein one or more said row, column, intersecting location, and interactive feature variables accept input comprising text, numbers, data, pictures, audio, video, graphics, scans, fax, voice, and animations.

3. The size table template of claim 1, wherein one or more said row, column, intersecting location, and interactive feature variables are definition assignable, modifiable, combinable, and enableable with at least one said interactive feature.

4. The size table template of claim 1, wherein said interactive feature variable comprises at least one interactive feature comprising: select by clicking; select by tapping; sliding; highlighting; hyperlinks; linking; buttons; widget activated features; one or more popup windows; a secure login feature; create and save an account feature, measuring feature, one or more data mouse over popup windows; one or more audio features; one or more video features; how to use, wear, and measure features; an item ratings input feature; an item review input feature; a calculator; a conversion calculator; a notepad; a size suggester; a fitting system; a place item into shopping cart feature; and a printable measuring tape feature.

5. The size table template of claim 1, further comprising sections, said sections comprising size suggesters, feedback and rating systems, information, multiple table layer tabs, combinations of more than one said section, and customizable sections; said sections may be variable, input accepting, modifiable, selectable, movable, zoomable in and out, placeable, stackable, interactive, and publishable; and said sections may accept input comprising text, numbers, data, pictures, audio, video, graphics, scans, fax, voice, and animations.

6. The size table template of claim 1, further comprising layers, whereby one or more additional size table templates may be opened, selected, stacked, brought forward, pushed back, and closed.

7. The size table template of claim 1, wherein said computing system generates one or more Interactive Size Tables from at least one said size table template allowing a client to publish, modify, republish, distribute, and store said Interactive Size Table, and, a user to access and interact with said Interactive Size Table online.

8. An Interactive Size Table comprising:
one or more rows with one or more row descriptors;
one or more columns with one or more column descriptors;
one or more reference descriptors located where row descriptors intersect column descriptors;
at least one interactive feature;
a computing system.

9. The Interactive Size Table of claim 8, wherein said row descriptors, column descriptors, and reference descriptors display customizable labels comprising sizes, size ranges, dimensions, measurements, measurement ranges, weights, weight ranges, quantifications, titles, letters, numbers, letter and number combinations, country name, and customizable labels.

10. The Interactive Size Table of claim 8, wherein said computing system generates, publishes, distributes, and stores said Interactive Size Table.

11. The Interactive Size Table of claim 8, wherein said computing system generates and publishes said Interactive Size Table from at least one template.

12. The Interactive Size Table of claim 8, wherein a user interacts with said Interactive Size Table, said user has interaction options comprising choosing to open an Interactive Size Table; selecting a size; selecting to have a size suggested; placing a selected size in another location; switching from one Interactive Size Table to another; choosing to open a fitting system; making calculations; printing a measuring tape; watching and listening to instructional audio and video; using a notepad; and inputting a review, a rating, and feedback by choosing from multiple formats; placing item in shopping cart; and exiting session.

13. The Interactive Size Table of claim 8, further comprising one or more sections, said sections capable of being selected and interactive.

14. The Interactive Size Table of claim 8, wherein said interactive features are selected from a group comprising select by clicking; select by tapping; highlighting; hyperlinks; buttons; one or more popup windows; one or more layers; a secure login feature; create and save a user profile; measurements; items viewed; purchased to my account feature; one or more data mouse over popup windows; one or more audio features; one or more video features; how to use, wear, and measure features; an item ratings input feature; an item review input feature; a calculator; a conversion calculator; a notepad; a size suggester; a fitting system; a place item into shopping cart feature; and a printable measuring tape feature.

15. A computer system comprising:
a processing site with at least one database configured to store data;
a Variable Size Table Template Module configured to store at least one Variable Size Table Template;
a Variable Size Table Generator Module configured to generate an Interactive Size Table on a generation interface, wherein the generation interface is configured to enable generation of the Interactive Size Table from data stored in said database which populates the Variable Size Table Template stored in the Variable Size Table Template Module;
a Publishing Module configured to enable the distribution of the generated Interactive Size Table.

16. The system of claim 16, further comprising one or more user interfaces, wherein said interfaces are configured to securely receive input into the system and to display output transmitted by the system.

17. The system of claim 16, wherein said Publishing Module is configured to publish and distribute at least one Interactive Size Table with at least one interactive feature.

18. The system of claim 16, wherein said Publishing Module is configured to publish at least one Interactive Size Table with the size selection interactive feature.

19. The system of claim 16, wherein said generating interface comprises size table variable defining and variable values and is configured to receive user data and populate one or more Variable Size Table Templates, wherein said generating module automatically generates at least one Interactive Size Table from data stored at the processing site.

20. A computer-implemented method comprising:
allowing a user to enable an Interactive Size Table;
opening a client generated Interactive Size Table;
allowing a user to select an interactive size from the Interactive Size Table;
allowing a user to verify size selection;
counting an Interactive Size Table interaction;
adding said counting to a client user account record;
placing a user selected size in same location as the corresponding item;
getting permission from a user to add the selected item with selected size into an online shopping cart;
placing a selected item into an online shopping cart;
counting an Interactive Size Table interaction with shopping cart placement;
adding said counting to said client user account record;
allowing a user to continue shopping;
allowing a user to end session;
allowing a user permission to later leave feedback;
opening the Interactive Size Table;
receiving a user request to access a feedback section of the Interactive Size Table;
verifying that a user purchased feedback item;
granting a user permission to interact with requested feedback section;
allowing a user to leave feedback input proximate the item on the corresponding Interactive Size Table;
storing the user feedback input in the database;
publishing the user feedback on the feedback section of the Interactive Size Table;
sending a copy of the user feedback to the client user account;
charging the client user account using the client data purchase billing interface;
allowing a user to end session.
